(19) United States
(12) Patent Application Publication
(10) Pub. No.: US 2006/0232048 A1
(43) Pub. Date: Oct. 19, 2006

(54) Curtain airbag with means of fixing it to the vehicle

(75) Inventors: Philippe Schneeweiss, Vigo (ES); Pedro Jose Santin Navarro, Vigo (ES)

Correspondence Address: LADAS & PARRY, 26 WEST 61ST STREET, NEW YORK, NY, 10023, US

(73) Assignee: DALPHI METAL ESPANA, S.A.

(21) Appl. No.: 11/134,858

(22) Filed: May 20, 2005

(30) Foreign Application Priority Data
Apr. 13, 2005 (WO) ES2005/070042

(51) Int. Cl. B60R 21/213; B60R 21/217

(52) U.S. Cl. 280/728.2; 280/730.2

(57) ABSTRACT

A curtain airbag incorporating means of fixing it to the vehicle so as to facilitate the assembly process and assure its perfect fixing, consisting of a clipping part, a screw and, optionally, an additional part cooperating with the clipping part so as to retain the screw in each one of the lugs of the airbag cover.

### FIELD OF THE INVENTION

The present invention refers to a curtain airbag, and particularly to a curtain airbag for automotive vehicles incorporating means for fixing thereof to the vehicle.

### BACKGROUND OF THE INVENTION

Curtain airbags usually refer to those airbags which are deployed in parallel to the sides of a vehicle, from top to bottom, to protect the occupants therein against side impacts.

These curtain airbags serve to absorb side collisions.

Curtain airbags are usually fixed to the roof of the vehicle and when a side impact is detected, they receive the gas at one end or in the center of the bag from a generator allowing them to be quickly inflated so as to perform their function. Due to their location in the vehicle, curtain airbags usually need a flexible cover for containing the duly folded bag, unlike driver or passenger airbags which generally use rigid covers.

Curtain airbags with bags are known which are configured in different manners but many of them share some basic principles such as the demarcation of the inflatable areas in correspondence with the side windows of the vehicle and the fixing to the vehicle through lugs located on the top edge, intended for cooperating with different fixing means.

Airbags are known in this sense which use metal clips as fixing means. A drawback of these airbags is that the fixing of all the clips is not assured, since it is possible to assemble the vehicle roof headliners without having fixed all the clips.

Airbags are also known which use screws as fixing means and which, as in the previous case, have the drawback that the screwing down of all the screws is not assured since it is possible to assemble the roof headliners without having fixed all the screws. In any case, these airbags have the drawback that the assembly time is long since several screwing operations must be carried out.

The present invention is aimed at solving these drawbacks.

### SUMMARY OF THE INVENTION

The present invention provides that the curtain airbag incorporates means of fixing it to the vehicle so as to facilitate the assembly process and assure its perfect fixing. It is applied in general terms to any curtain airbag, the top edge of which includes a plurality of lugs demarcating the points for fixing it to the vehicle.

According to the invention, the airbag incorporates a clipping part and a screw with each lug, and optionally an additional part cooperating with the clipping part to retain the screw.

The clipping part, arranged on the side facing the vehicle, comprises means for being introduced in the holes of the vehicle provided for the fixing of the airbag which, on one hand, allow the provisional attachment of the airbag during the process of its assembly in the vehicle, and on the other the permanent fixing in cooperation with the screw.

The additional part arranged on the other side of the lug is formed so as to cooperate with the clipping piece so as to retain said screw between both parts and to fix the bag, such that the airbag can be supplied with all the elements necessary for its fixing to the vehicle.

These parts allow the fixing of the curtain airbag to the body of the vehicle to have the following features:

All the parts used for the fixing are incorporated in the airbag and joined to one another, such that supplying a curtain airbag with all the elements necessary for the fixing joined in a single assembly is provided.

Pre-fixing to the body is provided by means of the clipping part, allowing the temporary attachment of the airbag before carrying out the final fixing by means of screws.

Positioning of the folded bag of the airbag is provided by means of the clipping part, introducing a portion thereof between the folded bag and the cover. This portion may include a ramp so as to facilitate overcoming the headliners in the deployment of the airbag.

It does not allow the assembly of the roof without having screwed all the screws into the body.

It allows the assembly and removal of the airbag.

Once the screw is screwed into the body, it is not possible to separate the clipping part from the body.

Other features and advantages of the present invention will be inferred from the following detailed description of an illustrative and by no means limiting embodiment of the object in relation to the attached drawings.

### DESCRIPTION OF THE DRAWINGS

FIG. 1 shows a schematic perspective view of a curtain airbag.

FIG. 2 shows a schematic perspective view of the two parts and the screw used for fixing the airbag to the vehicle, incorporated thereto.

FIG. 3 shows a schematic perspective view of the clipping part.

FIG. 4 shows a sectional view of the airbag according to the invention when it is pre-fixed to the body.

FIG. 5 shows a sectional view of the airbag according to the invention when it is permanently fixed to the body.

FIG. 6 shows a schematic perspective view of the two parts and the screw used for fixing the airbag to the vehicle in the position corresponding to the permanent fixing.

### DETAILED DESCRIPTION OF THE INVENTION

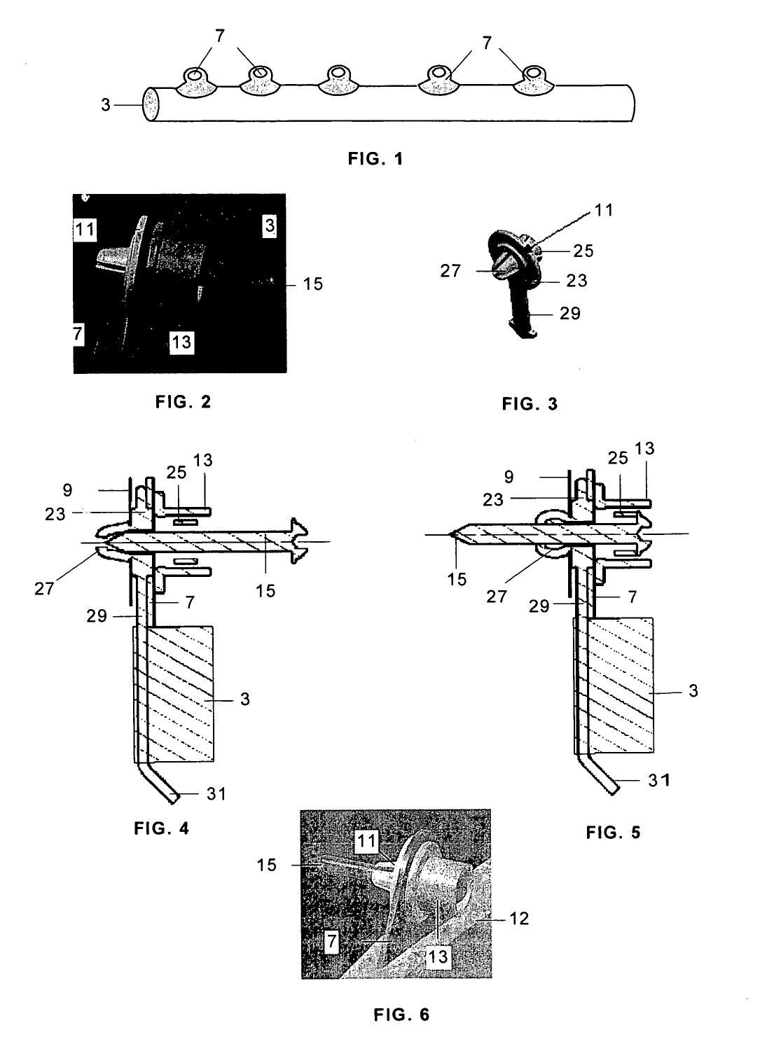

As can be seen in FIG. 1, a curtain airbag intended for being assembled in a vehicle is formed by a folded bag 3 contained in a cover, the top edge of which includes a plurality of lugs 7 so as to facilitate its fixing to the roof of the vehicle. The bag 3 of the curtain airbag has at least one compartment that can be inflated by means of the gas supplied by a gas generator (not shown) when the vehicle is involved in a collision.

In the embodiment of the invention that will be described below in reference to FIGS. 2-6, the means used for fixing the airbag to the vehicle are the clipping part 11, the additional part 13 and the screw 15.

The clipping part 11 is formed by a center plate 23 with an internal hole, a tubular body 25 towards the side opposite to the body of the vehicle and a plurality of resilient tabs 27 in the form of sections of a cone towards the side facing the body of the vehicle, suitable for being deformed during the permanent fixing of the screw, preventing the clipping part 11 from being separated from the body of the vehicle.

The clipping part 11 also includes a leg 29 which is introduced inside the cover of the bag 3 so as to maintain the inclination of the folded bag package according to the inclination of the body of the vehicle. As shown in FIGS. 4 and 5, the leg 29 may include a ramp 31 projecting from the bag 3 and facing the vehicle interior so as to facilitate deployment of the bag 3.

The additional part 13, which is incorporated in this embodiment of the invention but is not indispensable, is a sleeve formed so as to receive the tubular body 25 of the clipping part 11 such that both are joined by contact and can internally retain the locking screw 15.

The screw 15 may be grooved or smooth and round, square or oval shaped.

As shown in FIG. 2, the curtain airbag is provided with the clipping part 11 joined to the additional part 13 and the pre-screwed screw 15 for each lug 7, which is fixed between the clipping part 11 and the additional part 13.

The curtain airbag is temporarily fixed to the body 9 of the vehicle by introducing the tabs 27 of the clipping part 11 in the corresponding holes, as shown in FIG. 4, and then is permanently fixed as shown in FIGS. 5 and 6 (without showing the body of the vehicle in the last figure) when the screw 15 is passed through the tabs 27, deforming them.

Although an embodiment of the invention has been described and represented, modifications comprised within the scope of the invention can evidently be introduced in it, and the invention should not be considered limited to said embodiment but rather to the content of the following claims.

1. A curtain airbag for vehicles comprising a bag (3) contained in a cover with at least one compartment that can be inflated by means of the gas supplied by a gas generator when the vehicle is involved in a collision, the top edge of which includes a plurality of lugs (7) cooperating with screws (15) for fixing the airbag to the body (9) of the vehicle in holes provided for that purpose, characterized in that it also comprises a clipping part (11) for each lug (7) arranged on the side facing the vehicle, with means for being introduced in said holes and temporarily fixing the airbag during the process of its assembly in the vehicle, as well as for permanently fixing it in cooperation with a screw (15), said clipping part (11) having means of retaining said screw (15), such that the airbag can be provided with all the elements necessary for its fixing to the body (9) of the vehicle.

2. A curtain airbag for vehicles according to claim 1, characterized in that it further comprises an additional part (13) arranged on the other side of the lug (7) and having means cooperating with the clipping part (11) so as to retain said screw (15) between both parts.

3. A curtain airbag for vehicles according to claim 1, characterized in that the clipping part (11) is formed by a center plate (23) with an internal hole, a tubular body (25) facing the side opposite to the body of the vehicle and a plurality of resilient tabs (27) in the form of cone-shaped sections facing the body (9) of the vehicle which become deformed when traversed by the screw (15) during the permanent fixing of the airbag, preventing the clipping part (11) from being separated from the body (9) of the vehicle.

4. A curtain airbag for vehicles according to claim 3, characterized in that the additional part (13) is a sleeve formed so as to receive the tubular body (25) of the clipping part (11) so that both are joined by contact.

5. A curtain airbag for vehicles according to claim 2, characterized in that the clipping part (11) includes a leg (29) introduced inside the cover of the bag (3).

6. A curtain airbag for vehicles according to claim 5, characterized in that the leg (29) includes a ramp (31) facing the vehicle interior so as to facilitate deployment of the bag.

7. A curtain airbag for vehicles according to claim 2, characterized in that the clipping part (11) is formed by a center plate (23) with an internal hole, a tubular body (25) facing the side opposite to the body of the vehicle and a plurality of resilient tabs (27) in the form of cone-shaped sections facing the body (9) of the vehicle which become deformed when traversed by the screw (15) during the permanent fixing of the airbag, preventing the clipping part (11) from being separated from the body (9) of the vehicle.
